(19) United States
(12) Patent Application Publication
(10) Pub. No.: US 2015/0264209 A1
(43) Pub. Date: Sep. 17, 2015

(54) IMAGE PROCESSING APPARATUS AND IMAGE DISPLAY APPARATUS

(71) Applicant: FUJI XEROX CO., LTD., Tokyo (JP)

(72) Inventor: Keiko SHIRAISHI, Kanagawa (JP)

(73) Assignee: FUJI XEROX CO., LTD., Tokyo (JP)

(21) Appl. No.: 14/461,620

(22) Filed: Aug. 18, 2014

(30) Foreign Application Priority Data
Mar. 17, 2014 (JP) 2014-053685

(51) Int. Cl. H04N 1/00; H04N 1/44

(52) U.S. Cl. CPC H04N 1/00896; H04N 1/00408; H04N 1/00928; H04N 1/442; H04N 1/4433

(57) ABSTRACT

An image processing apparatus includes an operator determining unit, a receiving unit, and a display. The operator determining unit determines an operator of the image processing apparatus. The receiving unit receives, before the operator is determined by the operator determining unit, an operation that causes the image processing apparatus to perform image processing. The display displays, after the receiving unit has received the operation, an image used to cause the operator determining unit to determine the operator.

### CROSS-REFERENCE TO RELATED APPLICATIONS

This application is based on and claims priority under 35 USC 119 from Japanese Patent Application No. 2014-053685 filed Mar. 17, 2014.

### BACKGROUND

1. (i) Technical Field

The present invention relates to an image processing apparatus and an image display apparatus.

2. (ii) Related Art

Person presence sensor control is a way to automate power supply saving control for devices that are power supply targets.

### SUMMARY

According to an aspect of the invention, there is provided an image processing apparatus including an operator determining unit, a receiving unit, and a display. The operator determining unit determines an operator of the image processing apparatus. The receiving unit receives, before the operator is determined by the operator determining unit, an operation that causes the image processing apparatus to perform image processing. The display displays, after the receiving unit has received the operation, an image used to cause the operator determining unit to determine the operator.

### BRIEF DESCRIPTION OF THE DRAWINGS

An exemplary embodiment of the present invention will be described in detail based on the following figures, wherein:

FIG. 1 is a schematic diagram of an image processing apparatus according to a present exemplary embodiment;

FIG. 2 is a block diagram illustrating the configuration of a control system of the image processing apparatus according to the present exemplary embodiment;

FIG. 3 is an external view illustrating a user interface (UI) touch panel according to the present exemplary embodiment;

FIG. 4 is a diagram illustrating a side view of the image processing apparatus according to the present exemplary embodiment and a case where a user is facing the UI touch panel;

FIG. 5 is a front view of a display of the UI touch panel according to the present exemplary embodiment;

FIG. 6A is (the first half of) a flowchart illustrating a routine of monitoring and controlling of start-up in a sleep mode according to the present exemplary embodiment;

FIG. 6B is a flowchart illustrating a UI operation information storage control routine during authentication, the UI operation information storage control routine being executed at a point in time when the user faces the UI touch panel;

FIG. 7 is (the second half of) the flowchart illustrating the routine of monitoring and controlling of start-up in a sleep mode;

FIG. 8 is a timing chart according to the present exemplary embodiment when a start key is operated after authentication in the flow of start-up from the sleep mode caused by authentication;

FIG. 9 is a timing chart according to the present exemplary embodiment when the start key is operated during authentication in the flow of start-up from the sleep mode caused by authentication;

FIG. 10 is a front view of the display of the UI touch panel according to a modified example 1; and

FIG. 11 is a front view of the display of the UI touch panel according to a modified example 2.

### DETAILED DESCRIPTION

### Present Exemplary Embodiment

(Configuration of Image Processing Apparatus)

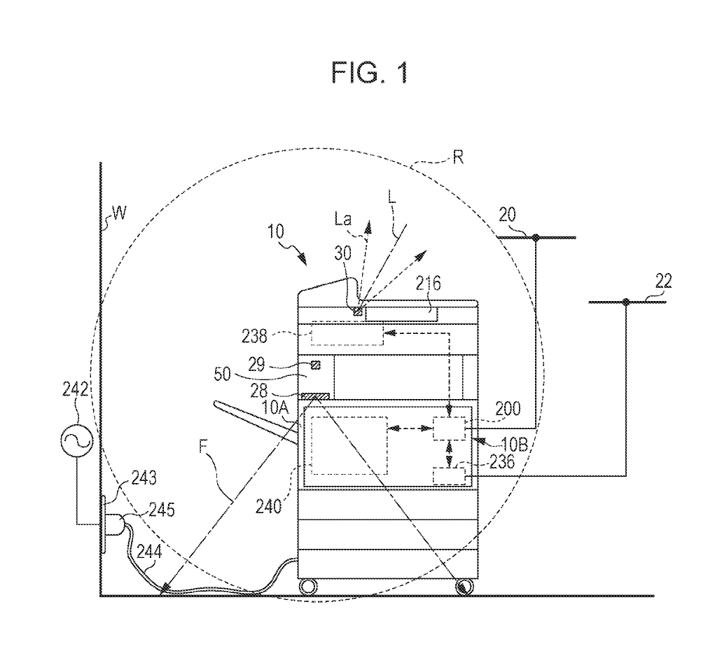

FIG. 1 illustrates an image processing apparatus 10 according to the present exemplary embodiment.

The image processing apparatus 10 has a housing 10A provided with doors that may be opened and closed at positions at which the doors are needed. For example, a front door 10B is illustrated in FIG. 1; however, doors may also be provided at right and left sides of the housing 10A. The front door 10B is opened in the case where an operator reaches inside the image processing apparatus 10 and does some work, for example, when a paper jam occurs, consumables are replaced, a periodic check is performed, or the like. The front door 10B is normally closed during operation.

The image processing apparatus 10 includes an image forming unit 240 that forms an image on a piece of recording paper, an image reading unit 238 that reads a document image, and a facsimile communication control circuit 236. The image processing apparatus 10 includes a main controller 200. The main controller 200 temporarily stores image data of a document image read by the image reading unit 238 or transmits the read image data to the image forming unit 240 or to the facsimile communication control circuit 236 by controlling the image forming unit 240, the image reading unit 238, and the facsimile communication control circuit 236.

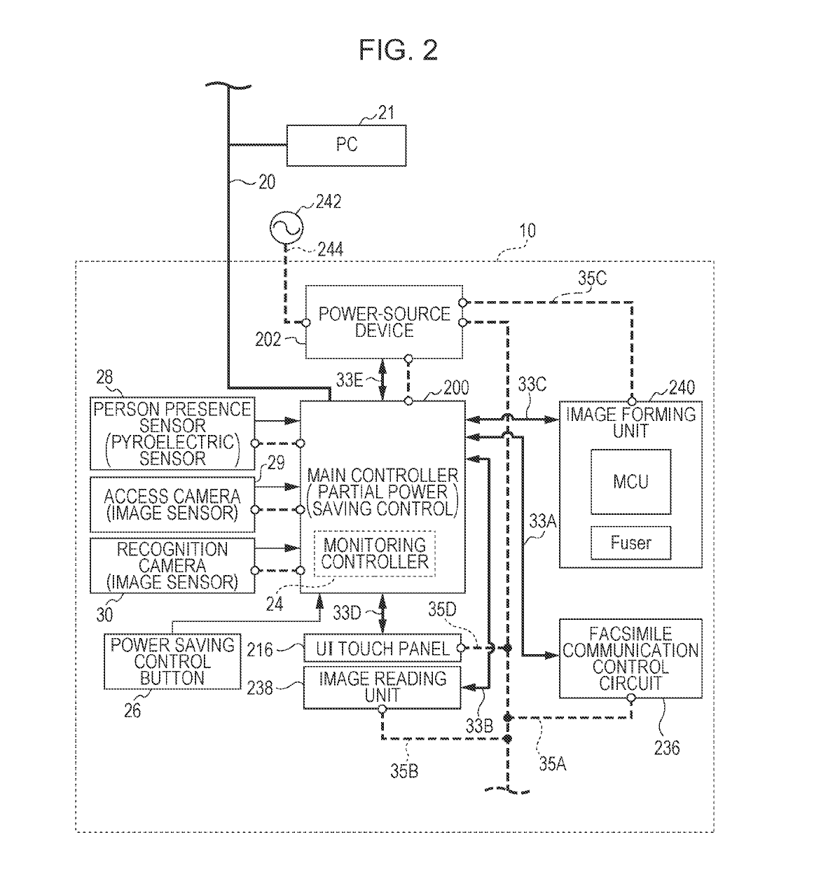

The main controller 200 is connected to a network-communication network 20 such as the Internet. The facsimile communication control circuit 236 is connected to a telephone network 22. The main controller 200 is connected to a host computer (for example, a PC 21 illustrated in FIG. 2) via, for example, the network-communication network 20 and receives image data. The main controller 200 sends and receives a fax via the facsimile communication control circuit 236 through the telephone network 22.

The image reading unit 238 includes a document plate, a scanning drive system, and a photoelectric conversion element. A document is positioned on the document plate. The scanning drive system scans an image formed on the document that is positioned on the document plate and irradiates the image with light. The photoelectric conversion element, which is for example a charge-coupled device (CCD), receives reflected or transmitted light, which is obtained by scanning the image with the scanning drive system, and converts the reflected or transmitted light into an electric signal.

The image forming unit 240 includes a photoconductor drum. Around the photoconductor drum, a charging device, a scanning exposure section, an image development section, a transfer section, and a cleaning section are provided. The charging device uniformly charges the photoconductor drum. The scanning exposure section scans the photoconductor drum using a light beam in accordance with image data. The image development section develops an electrostatic latent image that has been formed by scanning the photoconductor drum with the scanning exposure section in such a manner that the photoconductor drum is exposed to the light beam. The transfer section transfers an image that has been developed on the photoconductor drum, onto a piece of recording paper. The cleaning section cleans the surface of the photoconductor drum after transfer is performed by the transfer section. Furthermore, a fixing section that fixes the image which has been transferred onto the piece of recoding paper is provided along a path along which a piece of recording paper is transported.

The image processing apparatus 10 has an input power line 244, and a plug 245 is attached to an end of the input power line 244. The plug 245 is inserted into an outlet 243 provided on a wall surface W and wired into a commercial power source 242, so that the image processing apparatus 10 receives power from the commercial power source 242.

(Hardware Configuration of Control System of Image Processing Apparatus)

FIG. 2 is a schematic diagram of a hardware configuration of a control system of the image processing apparatus 10.

The main controller 200 is connected to the network-communication network 20. The facsimile communication control circuit 236, the image reading unit 238, the image forming unit 240, and a UI touch panel 216 are connected to the main controller 200 via buses 33A to 33D, respectively, such as data buses and control buses. In other words, the main controller 200 controls individual processing units of the image processing apparatus 10.

Furthermore, the image processing apparatus 10 includes a power-source device 202, and the power-source device 202 is connected to the main controller 200 via a harness 33E. The power-source device 202 receives power from the commercial power source 242. The power-source device 202 supplies power to the main controller 200 (see a dotted line in FIG. 2), and the power-source device 202 is provided with power supply lines 35A to 35D, which are independent of one another. Power is supplied to other devices, which are the facsimile communication control circuit 236, the image reading unit 238, the image forming unit 240, and the UI touch panel 216, through the power supply lines 35A to 35D, respectively. Accordingly, the main controller 200 may control power supply so as to selectively supply power to the individual processing units (devices) (a power-supply mode) or so as to selectively stop supplying power to the individual processing units (devices) (a sleep mode). As a result, so-called partial power saving control may be realized.

Moreover, plural sensors (a first sensor 28, a second sensor 29, and a third sensor 30) are connected to the main controller 200 and monitor whether or not there is a person in the surrounding area of the image processing apparatus 10. The first sensor 28, the second sensor 29, and the third sensor 30 will be described below.

(Monitoring Control for Changing State of Image Processing Apparatus)

Here, in some cases, the main controller 200 in the present exemplary embodiment may partially stop the functions thereof (partial power saving) in order to realize minimum power consumption. In some cases, power supply is shut off to the greater part of the main controller 200. Such cases may be collectively referred to as the “sleep mode” (a power saving mode).

The image processing apparatus 10 may enter the sleep mode, for example, by activating a system timer at a point in time when image processing ends. In other words, power supply is stopped after a predetermined time has elapsed since activation of the system timer. Note that, when a certain operation is performed (for example, a hard key 216B is operated) before the predetermined time elapses, as a matter of course, measurement of the predetermined time with the system timer for entering the sleep mode is stopped, and the system timer is activated at a point in time when the next image processing ends.

The main controller 200 includes a monitoring controller 24 serving as an element that constantly receives power even when the image processing apparatus 10 is in the sleep mode. The monitoring controller 24 may be provided separately from the main controller 200 and may include, for example, an integrated circuit (IC) chip, which is referred to as an application-specific integrated circuit (ASIC), in which an operation program is stored, and which includes a CPU, a RAM, a ROM, and so forth by which the operation program is performed.

When monitoring is performed while the image processing apparatus 10 is in the sleep mode, for example, a print request may be received via a communication-line detector or a facsimile (FAX) reception request may be received via a FAX line detector. In such a case, the monitoring controller 24 causes power to be supplied to devices for which power saving is being performed.

A power-saving control button 26 is connected to the main controller 200. The power saving mode may be canceled when a user operates the power-saving control button 26 while power saving is being performed. Note that the power-saving control button 26 may also have a function of forcibly shutting off power supply to processing units and causing the processing units to be in the power-saving state when the power-saving control button 26 is operated while power is being supplied to the processing units.

Here, even when the image processing apparatus 10 is in the sleep mode, which is a non-power-supply state, a processing unit may receive power whose amount is equal to or lower than a predetermined value (for example, 0.5 W or lower) and that is necessary to perform determination control as to whether or not power is to be supplied. In this case, the power supply source is not limited to the commercial power source 242, and may be a storage battery, a solar battery, a rechargeable battery that is recharged when power is supplied from the commercial power source 242, or the like. The commercial power consumption (or power expenses) while the image processing apparatus 10 is in the sleep mode may be zero by using no commercial power source 242.

(Application of Sensor)

In the case where a user who is standing in front of the image processing apparatus 10 operates the power-saving control button 26 during the sleep mode and power supply is restarted, there may be a case where a certain period of time is required for start-up of the image processing apparatus 10.

Thus, the first sensor 28 is connected to the monitoring controller 24 in the present exemplary embodiment. Furthermore, power supply is restarted early upon detection performed by the first sensor 28 before a user operates (or, for example, presses) the power-saving control button 26.

In the present exemplary embodiment, a person presence sensor may be applied as the first sensor 28 because the first sensor 28 senses movement of moving objects including a user. Hereinafter, the first sensor 28 is referred to as a “person presence sensor 28”.

The term person presence sensor 28 contains the words “person presence”. This is a proper noun in the present exemplary embodiment, and it is desirable that the person presence sensor 28 be capable of sensing, which is synonymous with detecting, at least persons. In other words, the person presence sensor 28 may also sense moving objects other than a person. Thus, in the following, there may be a case where what the person presence sensor 28 detects is referred to as a person; however, animals, robots, and the like that execute a requested order instead of a person will be future detection targets. Note that, in contrast, if there are special sensors that are capable of detecting and identifying a person, such a special sensor may be applied. In the following, a moving object, a person, a user, and the like are considered to be the same in terms of a detection target, which is to be detected by the person presence sensor 28, and are considered to be different from one another as necessary.

According to the specifications of the person presence sensor 28 according to the present exemplary embodiment, the first sensor 28 detects movement of a moving object in the surrounding area of the image processing apparatus 10. In this case, a representative example of the person presence sensor 28 is an infrared radiation sensor (a pyroelectric type sensor) using a pyroelectric effect of a pyroelectric element. In the present exemplary embodiment, a pyroelectric type sensor is applied as the person presence sensor 28.

The greatest feature of a sensor using a pyroelectric effect of a pyroelectric element, the sensor being applied as the person presence sensor 28, is that power consumption is lower and a detection area is broader than, for example, those of a reflex sensor provided with a projection section and a reception section. Since the person presence sensor 28 detects movement of a moving object, the person presence sensor 28 does not detect presence of a person when the person stays still even though the person is in the detection area. For example, there is a case where a high-level signal is output when a person is moving. When the person stays still in the detection area, the high-level signal becomes a low-level signal.

Note that “still” in the present exemplary embodiment includes not only a notion of absolute standstill as in still images taken by still cameras or the like but also a case where, for example, a person stops in front of the image processing apparatus 10 so as to perform an operation. Thus, “still” in the present exemplary embodiment also includes a case where a person moves slightly (for example, due to breathing) within a predetermined range and a case where a person moves arms, legs, the neck, or the like within a predetermined range.

Note that, when a person performs stretching exercise or the like in front of the image processing apparatus 10 while the person is waiting for, for example, completion of image forming processing, image reading processing, or the like, the person presence sensor 28 may detect the presence of the person.

Thus, the sensitivity of the person presence sensor 28 does not have to be adjusted by defining what is considered to be “still”, and may be adjusted relatively roughly and in a standard manner so as to depend on the sensitivity characteristics of the person presence sensor 28. That is, when the person presence sensor 28 outputs one of binary signals (for example, a high-level signal), this means that a person is present in the detection area and the person is moving. When the other one of the binary signals (for example, a low-level signal) is output, this means “still”.

In the present exemplary embodiment, when the person presence sensor 28 detects the moving object, power supply to the second sensor 29 is started. The second sensor 29 is connected to the monitoring controller 24. The second sensor 29 is in the power-supply shutoff state while the image processing apparatus 10 is in the sleep mode; however, power is supplied to the second sensor 29 when the person presence sensor 28 detects a moving object.

In the present exemplary embodiment, a sensor with a camera function for detecting movement information on a moving object (a user) (including distance information regarding how far or near the moving object is and movement direction information) is applied as the second sensor 29. Hereinafter, the second sensor 29 is referred to as an “access camera 29”.

The access camera 29 captures images with which at least the transition of the position of a moving object may be recognized. Note that, when the position of a moving object is detected, if the moving object emits a signal, a radar unit may be applied as the access camera 29; however, description will be made on the assumption that the moving object in the present exemplary embodiment emits no signal.

In the present exemplary embodiment, when it is determined using the access camera 29 that the moving object is approaching the image processing apparatus 10, especially the UI touch panel 216, for example, shifting from the sleep mode to a specific mode (in which power is supplied to the main controller 200, the UI touch panel 216, and the third sensor 30) is triggered.

Moreover, it is determined that a user is approaching the UI touch panel 216 also when it is “predicted” that the user is approaching the UI touch panel 216 and also in the case where the user makes a U-turn and does not face the UI touch panel 216 in the end.

In the present exemplary embodiment, in the case where the person presence sensor 28 detects the moving object, power supply to the third sensor 30 is started. The third sensor 30 is connected to an I/O unit 210 of the main controller 200.

In the present exemplary embodiment, a sensor with a camera function for detecting identity recognition information of a user is applied as the third sensor 30. Hereinafter, the third sensor 30 is referred to as a “recognition camera 30”.

The recognition camera 30 captures, for example, an image having characteristic information unique to a face of a user so as to detect identity recognition information of the user. The main controller 200 performs, using an image database regarding the characteristics of faces that has been stored in advance in a ROM or a HDD, verification and analysis in accordance with image information of a captured image having the characteristics of the face. As a result, for example, identity authentication is performed for the user or a personalized screen for the user is automatically displayed on an operation panel, the personalized screen being linked to information unique to the user.

Note that, a moving object that is approaching the image processing apparatus 10 is detected through the function of the access camera 29, and the identity of the moving object is authenticated through the function of the recognition camera 30 in the present exemplary embodiment. However, a moving object that is approaching the image processing apparatus 10 may be detected and the identity of the moving object may be authenticated through the function of the access camera 29, and a UI screen appropriate for the authenticated moving object may be selected or the like and a user-friendly and simpler operation procedure may be realized through the function of the recognition camera 30.

The identity recognition information is used to determine whether or not the user has the right to access the image processing apparatus 10, to determine which types of device or the like are to be used, and to control the operation of the image processing apparatus 10.

For example, the identification information of the user, which is the identity recognition information, is registered in advance together with a corresponding job type from a PC 21 on the desk of the user. After an image of a face or the like of the user is captured, the corresponding job type may be specified by executing an authentication process in accordance with information of the image of the face and by verifying the identification information obtained from the information of the image of the face against the identification information that has been registered together with the corresponding job type.

(Arrangement Configuration of Person Presence Sensor 28, Access Camera 29, and Recognition Camera 30)

As illustrated in FIG. 1, the person presence sensor 28 and the access camera 29 are provided on a pillar unit 50 on the housing 10A of the image processing apparatus 10. The pillar unit 50 has a vertically elongated rectangular shape. Moreover, the recognition camera 30 is provided near the UI touch panel 216.

The pillar unit 50 is provided at a portion that connects an upper housing that mainly covers the image reading unit 238 and a lower housing that covers mainly the image forming unit 240. The pillar unit 50 has a column shape. In the pillar unit 50, a recording paper transport system and the like, not illustrated, are installed.

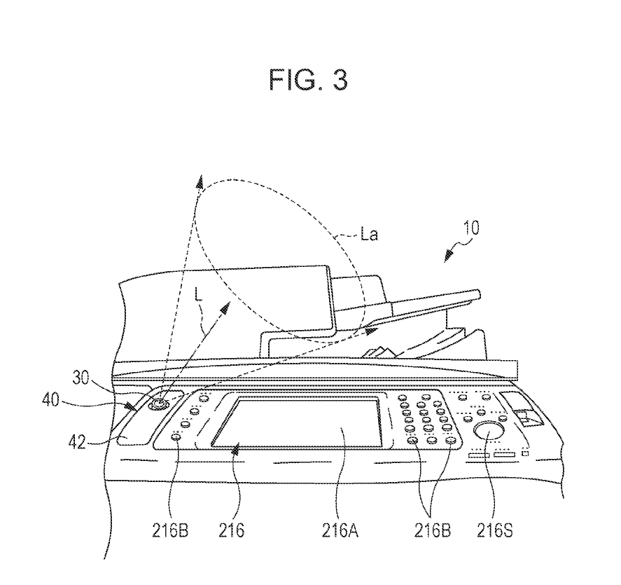

As illustrated in FIG. 3, a recognition camera unit 40 is provided at a position next to and to the left of the UI touch panel 216 in the image processing apparatus 10.

In the recognition camera unit 40, a lens surface of the recognition camera 30 is exposed at the surface of a base unit 42. The lens surface of the recognition camera 30 is arranged such that an image is optically formed on an image pickup device (not illustrated) provided in the backside of the base unit 42.

The optical axis (see an arrow L of FIG. 3) of the recognition camera 30 is adjusted to be at a standard position before shipment in such a manner that an image of a face of a user 60 who will soon face or is facing the UI touch panel 216 of the image processing apparatus 10 may be captured.

Moreover, an image capturing timing of the recognition camera 30 is controlled so as to cooperate with the person presence sensor 28 and the access camera 29. That is, power supply to the recognition camera 30 is shut off at least while the image processing apparatus 10 is in the sleep mode. In the case where a moving object is detected by the person presence sensor 28 and it is predicted using the access camera 29 that the user 60 will soon face the UI touch panel 216 while the image processing apparatus 10 is in the sleep mode, power is supplied to the recognition camera 30 and image capturing is started.

Note that when power is supplied to the recognition camera 30 and image capturing is started, a so-called through-the-lens image (a moving image) is captured and the moving image that is being captured is displayed on a display 216A of the UI touch panel 216. The display 216A serves as a touch panel that may be used for both displaying and inputting.

The user (a subject) adjusts the position of the face while checking the through-the-lens image displayed on the display 216A.

By analyzing the through-the-lens image captured by the recognition camera 30, it is determined whether or not the user is facing the UI touch panel 216. When the position of the face matches a predetermined appropriate position, a so-called still image is captured. (A feature image is captured.)

For the user, identity authentication analysis is executed on the basis of this feature image. The main controller 200 executes identity recognition for the user 60, who is facing the UI touch panel 216. When the user 60 is identified, power supply control to individual devices of the image processing apparatus 10 is executed. Identity authentication in the present exemplary embodiment is face authentication.

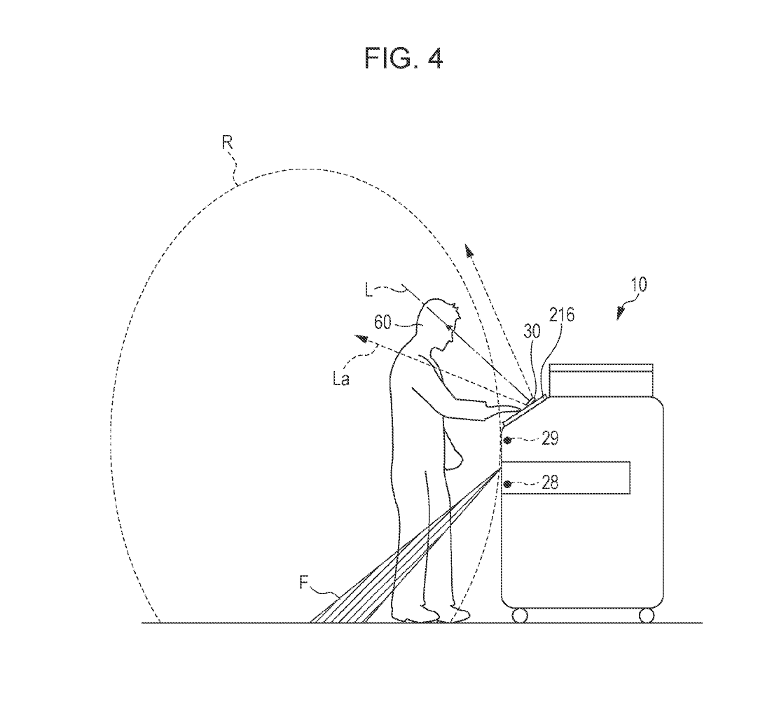

FIG. 4 illustrates an example of comparison between a detection area F of the person presence sensor 28, a detection area R of the access camera 29, and a detection area La of the recognition camera 30.

The detection area F is a detection area of the person presence sensor 28, has a sector shape and a wide angle (on the order of 100° to 120°) from an installment position of the person presence sensor 28 in the width direction, and faces toward the floor surface on which the image processing apparatus 10 is installed.

In contrast, an area defined by a dotted line R is the detection area R of the access camera 29. The detection area R of the access camera 29 covers an area that the detection area F of the person presence sensor 28 does not cover.

The area represented by arrows La drawn with a dotted line, the center line of the area being the optical axis L, is the detection area La (an image capturing area) of the recognition camera 30. The recognition camera 30 captures an image of a face of the user 60 in the case where the user 60 will soon face or is facing the UI touch panel 216.

Here, for image capturing (of an image such as a through-the-lens image and a still image) performed by the recognition camera 30, it is important to guide the user 60 into a predetermined area appropriate for image capturing in order to assuredly perform face authentication for the user 60. In addition, it is important to notify the user 60 of what image is to be used for face authentication.

Thus, a through-the-lens image is displayed on the display 216A of the UI touch panel 216 (see FIG. 3) such that the user 60 is guided, and a still image to be applied to face authentication is displayed.

However, there may be a case where the user 60 approaches the image processing apparatus 10 and then performs an input operation using an input function of the UI touch panel 216 (a touch operation panel used also as an area of the display 216A, and hard keys 216B positioned near the display 216A illustrated in FIG. 3) as soon as the user 60 faces the UI touch panel 216. Note that the hard keys 216B includes a start key 216S.

Here, on the display 216A, in a face authentication process using the recognition camera 30, a through-the-lens image is displayed before a feature image has been determined and a still image is displayed after the feature image is determined. Thus, the user 60 needs to wait till completion of face authentication. In the case where face authentication is performed and the user 60 is not authenticated, since the user 60 is not allowed to use the image processing apparatus 10, there is basically no inconvenience. However, for the user 60 who has already reached the UI touch panel 216 and believes that there is no doubt that the user 60 is authenticated, a time for face authentication is an inconvenient waiting time.

In the present exemplary embodiment, on the display 216A of the UI touch panel 216, first regions 216C1 to 216C6 functioning as a guiding image for the touch operation panel (hereinafter they may be generally referred to as a “first regions 216C”) and a second region 216D that displays a through-the-lens image and a still image are provided.

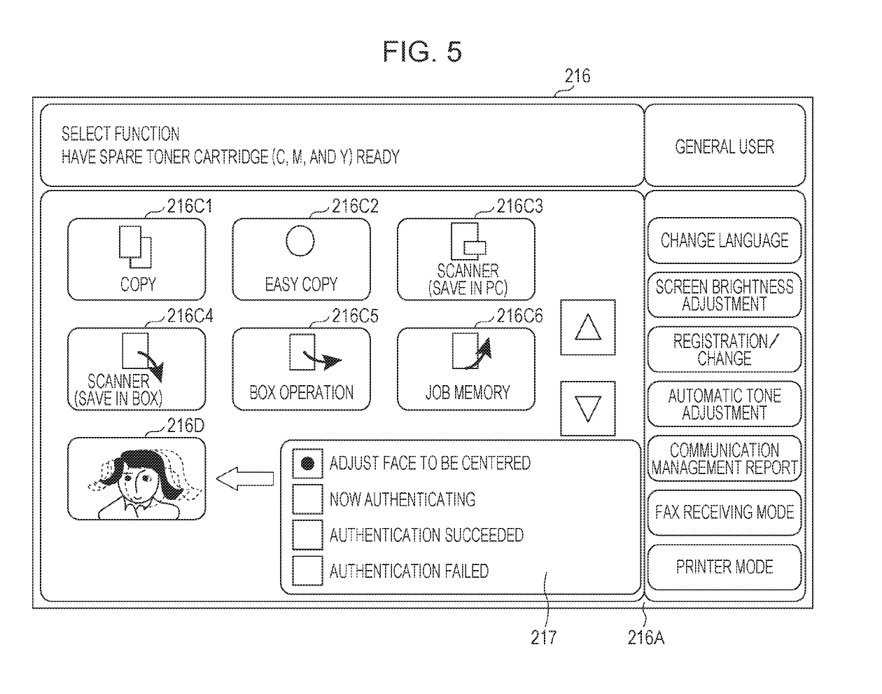

FIG. 5 illustrates an example in which the first region 216C and the second region 216D are provided on the display 216A of the UI touch panel 216.

As illustrated in FIG. 5, the first region 216C is a menu screen serving as an example of a guiding image for the image processing apparatus 10. The first region 216C includes areas defined by plural rectangular frames 216C1 to 216C6 for respective functions to be executed. By touching the inside of each of the frames 216C1 to 216C6, the function displayed inside the corresponding one of the frames 216C1 to 216C6 (for example, copy, easy copy, scanner (save in PC), scanner (save in box), box operation, and job memory) may be selected.

Here, in the present exemplary embodiment, the second region 216D is provided so as to have almost the same size as the frames 216C1 to 216C6, and is displayed so as to be arranged together with the frames 216C1 to 216C6. Note that, an authentication guiding display frame 217 is displayed in association with the second region 216D.

As a result, the second region 216D is displayed in a portion of the first region 216C, and its display area is on the order of 1/10 of that of the first region 216C (hereinafter referred to as “an area ratio of 1/10”).

By providing the first region 216C functioning as a touch panel and the second region 216D that displays a through-the-lens image and a still image on the display 216A of the UI touch panel 216, the user 60 may perform a touch operation through the first region 216C while checking a through-the-lens image displayed on the second region 216D and while adjusting the position of the face to reach a predetermined position.

In addition, by providing the first region 216C functioning as a touch panel and the second region 216D that displays a through-the-lens image and a still image on the display 216A of the UI touch panel 216, the user 60 may perform a touch operation through the first region 216C even while face authentication is being performed on the basis of a still image displayed on the second region 216D.

Furthermore, by providing the first region 216C functioning as a touch panel and the second region 216D that displays a through-the-lens image and a still image on the display 216A of the UI touch panel 216, the size of a through-the-lens image and that of a still image become smaller than the size of the entirety of the display 216A (in the present exemplary embodiment, “an area ratio of 1/10”, see FIG. 5).

In the following, an operation of the present exemplary embodiment will be described.

The operation state of the image processing apparatus 10 shifts to the sleep mode when no processing is performed. In the present exemplary embodiment, power is supplied only to the monitoring controller 24.

Here, when start-up is triggered (when it is predicted using the access camera 29 that the user 60 is approaching the image processing apparatus 10, when an operation for canceling the power saving mode is performed, or when an input operation (for example, an operation performed using a key) is performed through the UI touch panel 216 or the like), the main controller 200, the UI touch panel 216, and the recognition camera 30 are started up. For example, in the case where a user who has been authenticated through face recognition by the image processing apparatus 10 inputs an operation (a job) (using keys) through the UI touch panel 216 or the like, the image processing apparatus 10 enters a warm-up mode in accordance with the type of job.

When a warm-up operation ends in the warm-up mode, the image processing apparatus 10 shifts to a standby mode or a running mode.

In the standby mode, the image processing apparatus 10 is literally in a mode in which the image processing apparatus 10 is ready for operation. The image processing apparatus 10 is in a state in which the image processing apparatus 10 may perform operation for image processing at any time.

Thus, a job execution operation is commanded as an input performed using a key, the operation state of the image processing apparatus 10 shifts to the running mode and image processing according to the commanded job is executed.

When image processing ends (or when all sequential jobs end in the case where sequential and plural jobs are waiting in a queue), this triggers standby and the operation state of the image processing apparatus 10 shifts to the standby mode.

When a job is commanded to be executed while the image processing apparatus 10 is in the standby mode, the operation state of the image processing apparatus 10 shifts to the running mode again. In contrast, for example, in the case where the access camera 29 detects that the user 60 is away from the image processing apparatus 10 (or it is predicted using the access camera 29 that the user will soon be away from the image processing apparatus 10) or in the case where a predetermined time has elapsed, the operation state of the image processing apparatus 10 shifts to the sleep mode.

In the present exemplary embodiment, power supply control is executed in such a manner that the person presence sensor 28, the access camera 29, and the recognition camera 30 cooperate with each other. More specifically, power is constantly supplied to the person presence sensor 28; however, control is performed in accordance with detection information supplied from the person presence sensor 28 in such a manner that power is sequentially supplied to the access camera 29 and to the recognition camera 30.

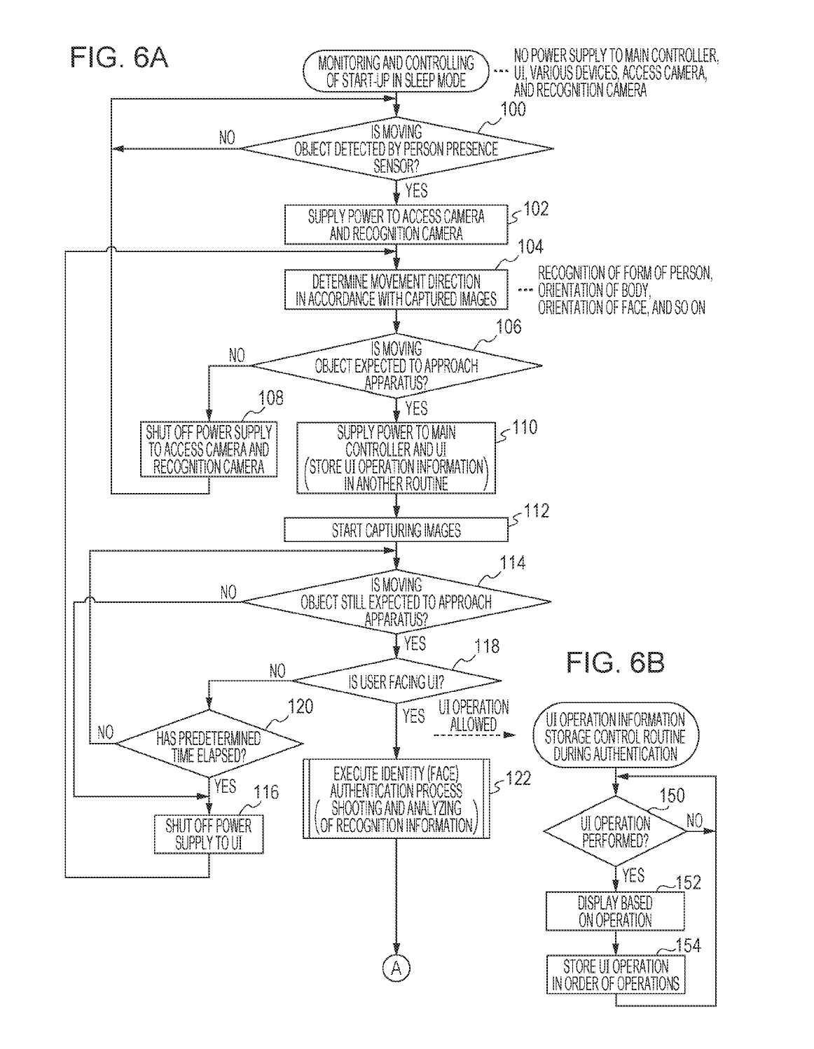

In the following, a power-supply control routine according to the present exemplary embodiment will be described in accordance with a flowchart illustrated in FIG. 6A. In the power-supply control routine, the person presence sensor 28, the access camera 29, and the recognition camera 30 cooperate with each other.

The processing procedure illustrated in FIG. 6A is started when the image processing apparatus 10 shifts to the sleep mode. While the image processing apparatus 10 is in the sleep mode, no power is supplied to the greater part of the main controller 200, the UI touch panel 216, various devices, the access camera 29, and the recognition camera 30. (That is, the greater part of the main controller 200, the UI touch panel 216, the various devices, the access camera 29, and the recognition camera 30 are in the power-supply shutoff state.) In contrast, power is supplied to the monitoring controller 24 in the main controller 200 and the person presence sensor 28. (That is, the monitoring controller 24 and the person presence sensor 28 are in the power supply state.) The power is on the order of, for example, 0.5 W.

In step 100, it is determined whether or not the person presence sensor 28 detects a moving object. If YES in step 100, the process proceeds to step 102. In step 102, the access camera 29 and the recognition camera 30 are started up.

In step 104, the direction in which the moving object is moving is determined in accordance with images captured by the access camera 29. As the direction in which the moving object is moving, the direction in which the moving object is expected to move is determined by recognizing at least the form of a person and by detecting the orientation of the person and the orientation of the face of the person (image analysis).

In step 106, it is determined whether or not it is predicted that the moving object (the user 60) is approaching the image processing apparatus 10 by the image analysis based on the images captured by the access camera 29. The reason that the determination in step 106 is made on the basis of “prediction” is that the determination is made assuming that the user 60 will soon move straight in the direction determined in step 104. For example, the moving object may change its course with respect to the direction determined in step 104 (that is, the moving object may turn right/left, make a U-turn, or the like). This is why the determination in step 106 is made on the basis of “prediction”.

If NO in step 106, that is, when it is predicted that the moving object is not moving toward the image processing apparatus 10, the process proceeds to step 108. In step 108, power supply to the access camera 29 and the recognition camera 30 is shut off, and the process returns to step 100.

In step 106, NO is obtained when the moving object detected by the person presence sensor 28 is, for example, a moving object that simply passes by the image processing apparatus 10. In the case where such a moving object is already away from the image processing apparatus 10, step 100 is repeated. In contrast, in the case where the moving object stays in the detection area of the person presence sensor 28 (the detection area F illustrated in FIG. 4), the access camera 29 and the recognition camera 30 are started up again.

Note that a delay time may be set before power supply to the access camera 29 and the recognition camera 30 is shut off in step 108, and image analysis of the moving object in the direction of movement may be continued during the delay time after the process returns to step 100. This makes it possible to compensate the dead-angle area of the person presence sensor 28.

If YES in step 106, that is, when it is predicted that the moving object is moving toward the image processing apparatus 10 (or it is predicted that the moving object is approaching the image processing apparatus 10), the process proceeds to step 110. In step 110, power is supplied to the main controller 200 and the UI touch panel 216.

In step 112, capturing of images is started using the recognition camera 30. Then, the process proceeds to step 114.

In step 114, it is determined whether or not the moving object (the user 60) is still approaching the image processing apparatus 10. This is because the moving object is once moving toward the image processing apparatus 10 but later may change its course. If NO in step 114, the process proceeds to step 116. In step 116, power supply to the UI touch panel 216 is shut off. Then, the process returns to step 104.

If YES in step 114, the process proceeds to step 118. In step 118, it is determined whether or not the user 60 is facing the UI touch panel 216. That is, it may be determined that the user 60 is facing the UI touch panel 216, by analysis of an image captured by the recognition camera 30 and execution of capturing of an image (especially, an image of a face) of the user 60.

If NO in step 118, that is, when it is determined that capturing of an image of the user 60 is unsuccessful, the process proceeds to step 120. In step 120, it is determined whether or not a predetermined time has elapsed. If NO in step 120, the process returns to step 114. Then, the above-described processing procedure (steps 114, 118, and 120) is repeated.

If YES in step 120, it is understood that the predetermined time has elapsed in a state in which the user 60 is approaching the image processing apparatus 10 but does not face the UI touch panel 216. Then, the process proceeds to step 116. In step 116, power supply to the UI touch panel 216 is shut off. Then, the process returns to step 104.

In step 120, YES is obtained, for example, in a state in which the user 60 is waiting for a printout that has been commanded from the PC 21 or the like on the desk of the user 60 at a position that is shifted from the front side of the image processing apparatus 10 (that is, at a position near the paper outlet tray), in a state in which the user 60 is working near the image processing apparatus 10 in order to replace consumables such as toner or recording paper, or the like.

On the other hand, if YES in step 118, that is, when it is determined that capturing of, for example, an image of the face of the user 60 is successful and the user 60 is facing the UI touch panel 216, the process proceeds to step 122. In step 122, an identity authentication process is executed.

In the identity authentication process, the captured image of the face is analyzed and compared with the face image database stored in advance in the ROM or the HDD (not illustrated) in the main controller 200, and it is determined whether or not the user 60 is a user with the right to use the image processing apparatus 10.

Here, when it is determined in step 118 that the user 60 is facing the UI touch panel 216, the user 60 may perform an operation through the UI touch panel 216. In the present exemplary embodiment, as illustrated in FIG. 6B, a UI operation information storage control routine to be performed during authentication is started up.

In the flowchart of FIG. 6B, a piece or pieces of information (UI operation information) regarding an operation or operations performed by the user 60 through the UI touch panel 216 during an authentication process to be executed (capturing of a through-the-lens image, capturing of a still image, and a face authentication analysis process) are stored in the order of operations.

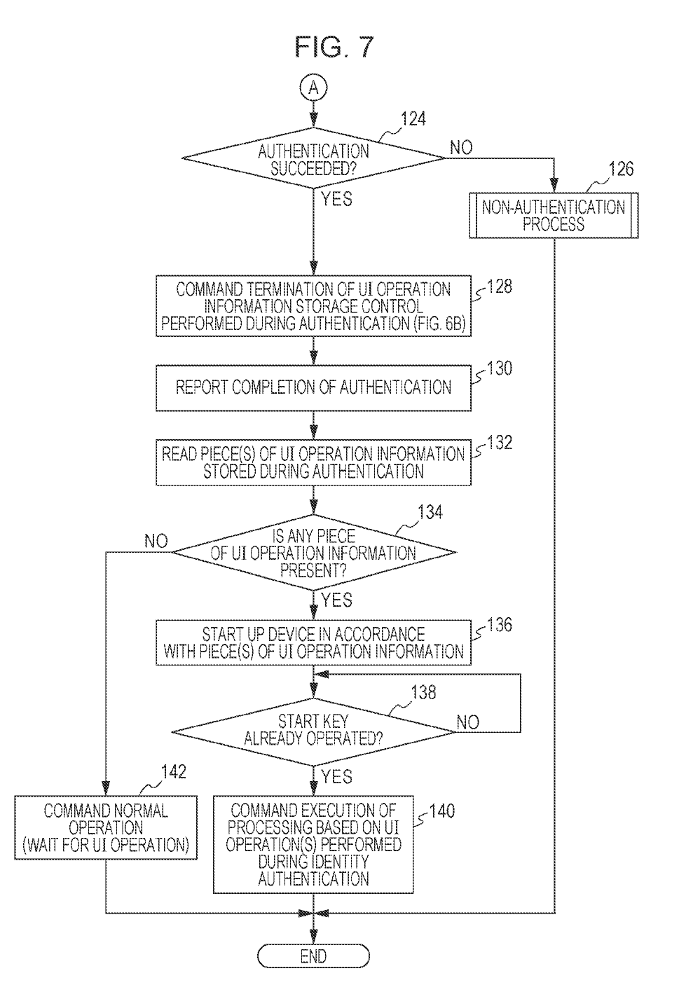

In step 150, it is determined whether or not an operation has been made through the touch operation panel of the UI touch panel 216 or using the hard keys 216B of the UI touch panel 216. If YES in step 150, the process proceeds to step 152. In step 152, display based on the operation is performed on the display 216A. Then, the process proceeds to step 154, and the operation is stored in the order of operations performed through the UI touch panel 216. Then, process returns to step 150. The routine of FIG. 6B is repeated until the face authentication process ends (see “command termination of UI operation information storage control performed during authentication” of step 128 of FIG. 7).

As illustrated in FIG. 6A, in the case where the identity authentication process is executed in step 122 and the identity authentication process ends, the process proceeds to step 124 of FIG. 7.

As illustrated in FIG. 7, in step 124, it is determined whether or not the user 60 has been authenticated in the identity authentication process.

If NO in step 124, the process proceeds to step 126 and a non-authentication process is executed. In the non-authentication process, a combination of processes may be performed from the processes including, for example, a process in which the authentication process is repeated a few times, a process in which, in the case where there is provided a card reader, an ID card is placed over the card reader and authentication is performed, a process in which a PIN number is manually input using a ten-key pad of the hard keys 216B and authentication is performed, and a process in which authentication is rejected. Note that, in the case where the user 60 is not authenticated, it is preferable that the piece or pieces of UI operation information stored in the flowchart of FIG. 6B be deleted.

In contrast, if YES in step 124, it is determined that the user 60 has been authenticated and the process proceeds to step 128. In step 128, the UI operation information storage control performed during authentication (the flowchart of FIG. 6B) is commanded to end and the process proceeds to step 130.

In step 130, completion of authentication is reported (for example, completion of authentication is displayed on the display 216A of the UI touch panel 216) and the process proceeds to step 132.

In step 132, the piece or pieces of UI operation information during authentication, that is, operation information is read and the process proceeds to step 134, the operation information being information in which touch operations performed on the first region 216C set on the display 216A of the UI touch panel 216 or operations performed using the hard keys 216B including the start key 216S are stored in the order of operations while the authentication process is being performed after the user 60 has faced the UI touch panel 216.

In step 134, it is determined whether or not any piece of UI operation information is present. If YES in step 134, it is determined that, during the authentication process, the user 60 has operated the first region 216C (the touch operation panel) or the hard keys 216B of the UI touch panel 216. Then, the process proceeds to step 136 and devices are started up in accordance with the piece of pieces of UI operation information. For example, in the case where the user 60 selects copy and places a document on the document plate of the image reading unit 238, power is supplied to the image reading unit 238 and the image forming unit 240.

In step 138, it is determined whether or not the user 60 has operated the start key 216S as a final operation during the authentication process. If YES in step 138, the process proceeds to step 140. In step 140, execution of processing based on the UI operation or operations performed during the identity authentication (for example, in the case where copy is selected, execution of a copy process) is commanded, and this routine ends.

In addition, if NO in step 138, the process waits till the start key 216S is operated. Then, execution of processing based on the UI operation or operations performed during the identity authentication (for example, in the case where copy is selected, execution of a copy process) is commanded and this routine ends.

In contrast, if NO in step 134, it is determined that, during the authentication process, the user 60 has not operated the first region 216C (the touch operation panel) or the hard keys 216B of the UI touch panel 216. Then, the process proceeds to step 142 and a normal operation is executed.

The normal operation is, for example, to display a menu appropriate for the authenticated user or to supply power to devices necessary for a job preregistered for the authenticated user (for example, in the case where printing is commended, power is supplied to the image forming unit 240) in accordance with the authentication result. Note that a standard menu screen may be simply displayed on the display 216A of the UI touch panel 216 and may be ready for receiving an operation input.

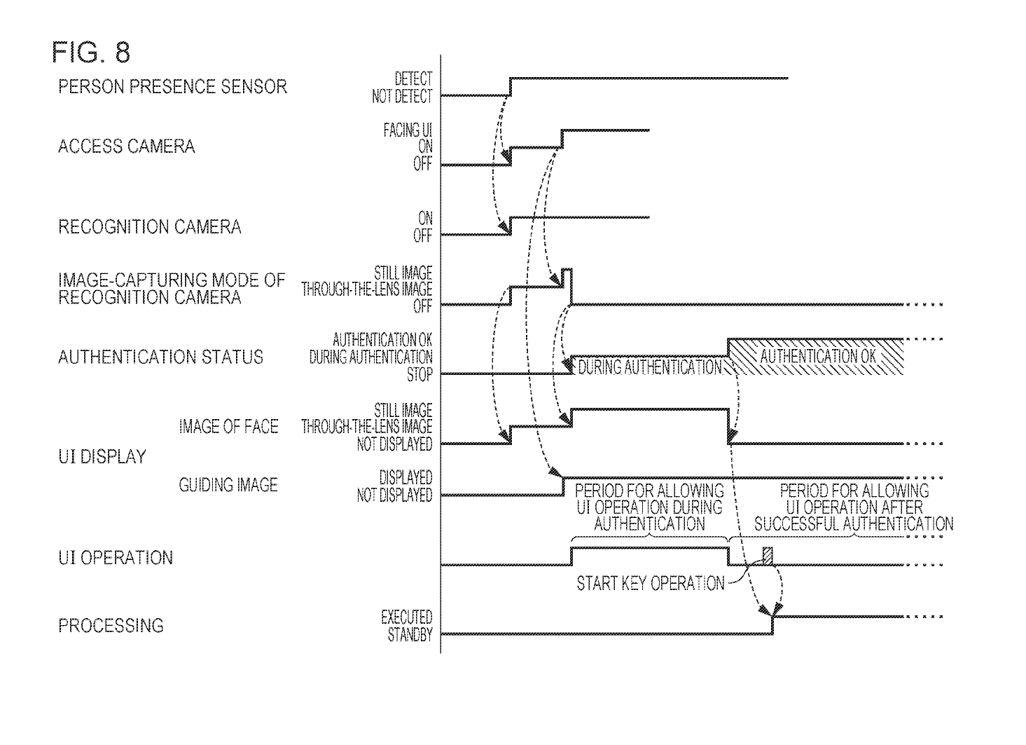

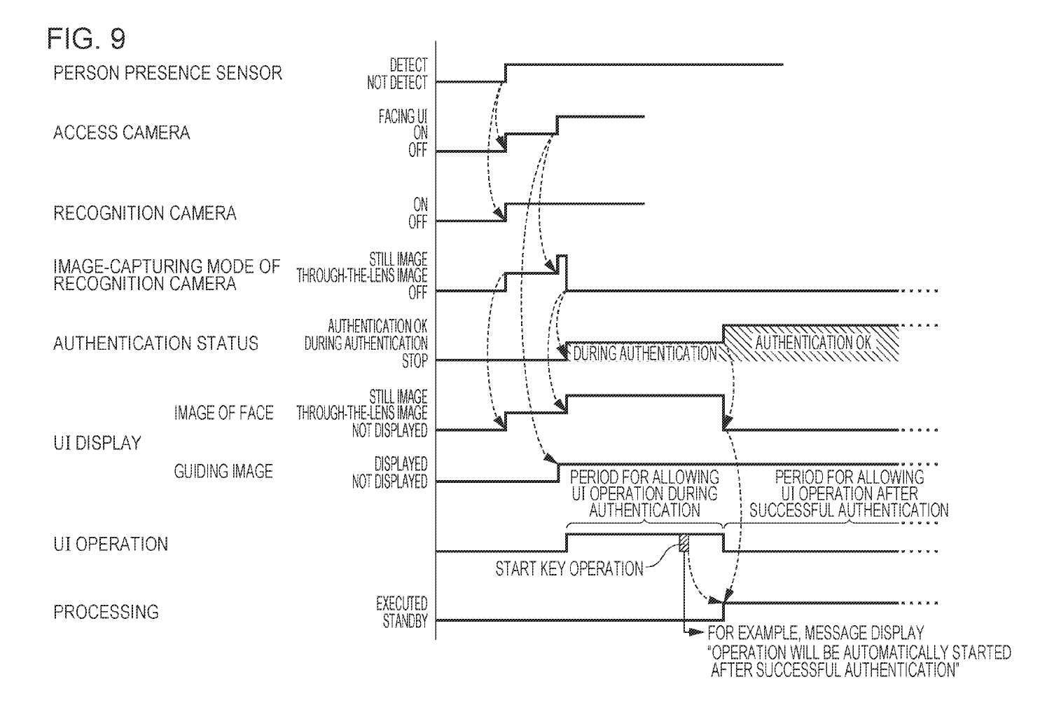

FIGS. 8 and 9 are timing charts illustrating a process in which the image processing apparatus 10 is started up from the sleep mode by performing face authentication and processing is executed in accordance with the flowchart of the FIGS. 6A to 7. These timing charts are based on the flowchart of FIGS. 6A to 7, and thus a detailed description will be omitted.

FIG. 8 is a timing chart in the case where the start key 216S is not operated during face authentication but operated after authentication (authentication OK). That is, in step 138 of FIG. 7, No is obtained and the process waits for a while after authentication. Thereafter, when the start key 216S is operated, processing is executed.

FIG. 9 is a timing chart in the case where the start key 216S is operated during face authentication. That is, in step 138 of FIG. 7, YES is immediately obtained and processing is executed soon after face authentication.

Note that, in the present exemplary embodiment, as an example in which the first region 216C functioning as a touch operation panel and the second region 216D that displays a through-the-lens image and a still image are provided on the display 216A of the UI touch panel 216, as illustrated in FIG. 5, the size (area) of the second region 216D is made to be on the order of 1/10 of the size (area) of the first region 216C (an area ratio of 1/10) by designing the second region 216D to have almost the same size as the frames 216C1 to 216C6 each illustrating a corresponding one of functions of the first region 216C. However, an example in which the first region 216C and the second region 216D are provided on the display 216A of the UI touch panel 216 is not limited to this. The following modified examples are applicable.

### Modified Example 1

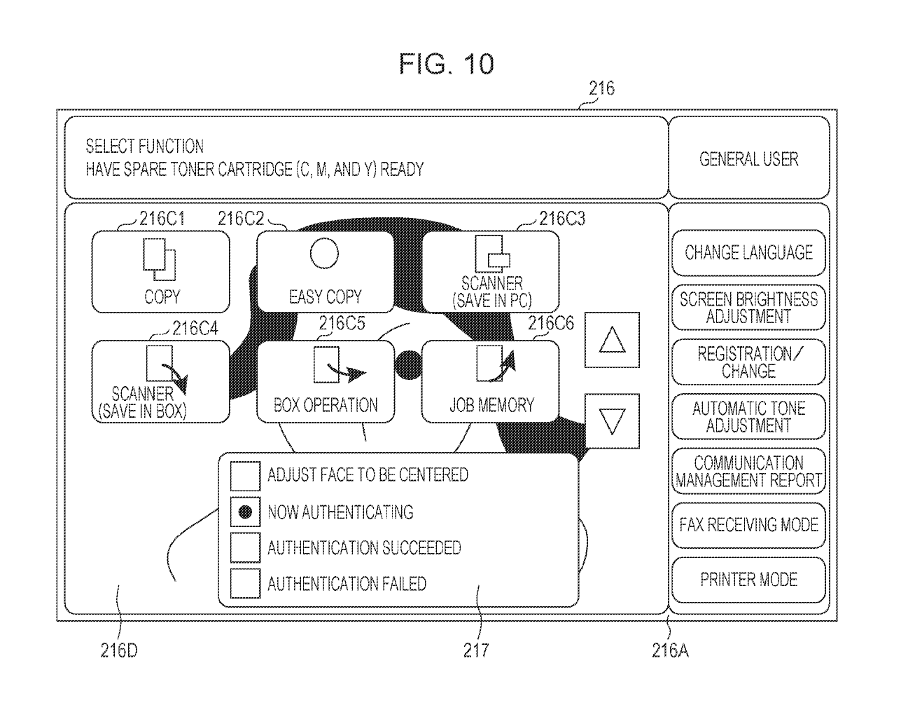

As illustrated in FIG. 10, the second region 216D is a background image of the frames 216C1 to 216C6 of the first region 216. Thus, the size of the second region 216D corresponds to the size of the entirety of the display 216A. The frames 216C1 to 216C6 and the authentication guiding display frame 217 are displayed with a higher priority (displayed on the front), and a through-the-lens image or a still image captured by the recognition camera 30 is partially seen from the gaps between the frames 216C1 to 216C6.

However, even with an image partially seen from these gaps, the position of a face may be adjusted using a through-the-lens image and it may be confirmed that the image is a still image.

### Modified Example 2

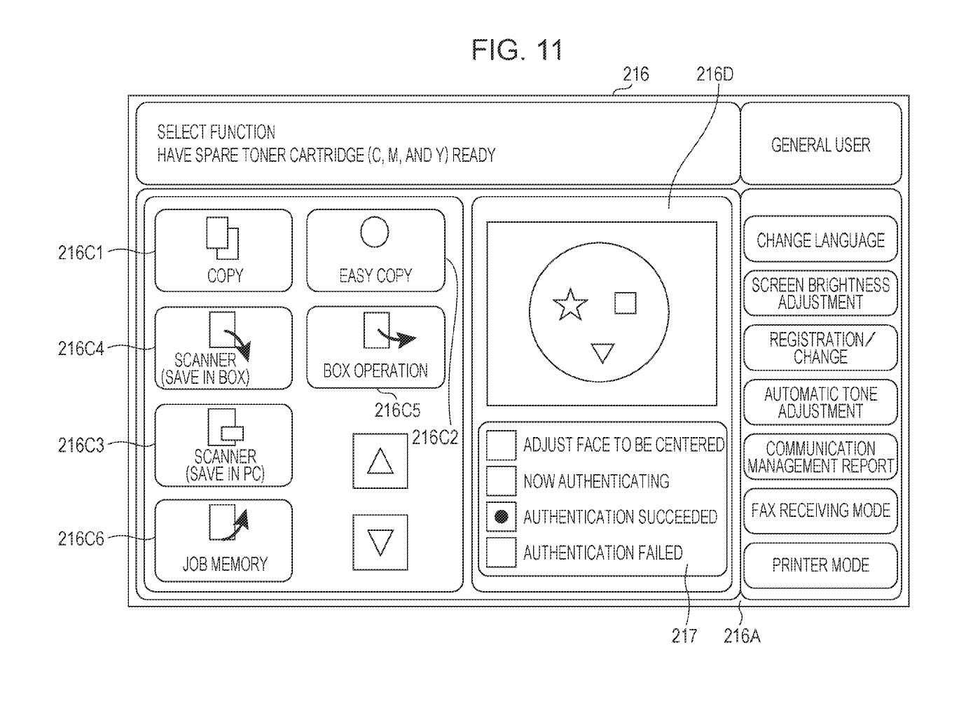

As illustrated in FIG. 11, in a modified example 2, the display 216A of the UI touch panel 216 is divided into two portions: left and right portions. One of them serves as the first region 216C and the other one serves as the second region 216D. Note that division into top and bottom portions may be performed instead and the shape of each portion does not have to be rectangular as long as the first region 216C may be distinguished from the second region 216D.

As illustrated in FIG. 11, the first region 216C is a menu screen of the image processing apparatus 10. The functions displayed inside the frames 216C1 to 216C6 (for example, copy, easy copy, scanner (save in PC), scanner (save in box), box operation, and job memory) may be selected.

In contrast, an image such as a through-the-lens image and a still image is displayed on the second region 216D. In this case, in a through-the-lens image and a still image displayed on the second region 216D, a preset character image 60A is displayed instead of the face of the user 60. Note that an image applied to the authentication process is an actual image of the user 60.

The character image 60A is an image which is not an image currently captured by the recognition camera 30. Examples of the character image 60A include a favorite image of the face of the user 60, an image of a face of an animal, an image of a face illustrated in a manga, and an image of a rendered face.

By displaying the character image 60A on the second region 216D, even with a through-the-lens image or a still image being captured by the recognition camera 30, at least the outline (size) and orientation of the user 60 may be determined.

In the modified example 2, the user 60 adjusts the position of the character image 60A while looking at the character image 60A. In addition, the character image 60A is a still image during face authentication.

Note that the present exemplary embodiment (including all the modified examples) includes the following examples.

### Example 1

A face authentication apparatus includes a face authenticating unit that executes a face authentication process for determining, in accordance with an image of a face of a user captured when the user faces a touch panel portion, whether or not to allow execution of processing, and

a display controller that displays the captured image of the face during the face authentication process performed by the face authenticating unit on the touch panel portion and displays a guiding image with a higher priority than the captured image of the face, the guiding image being used to guide an input operation before the face authentication process performed by the face authenticating unit ends.

### Example 2

The face authentication apparatus according to the example 1 further includes a reporting unit that reports a determination result of face authentication performed by the face authenticating unit.

### Example 3

In the face authentication apparatus according to the example 1 or 2, priority is represented by the size of an image area to be displayed, and

an image area in which the guiding image is displayed is larger than an image area in which the image of the face is displayed.

### Example 4

In the face authentication apparatus according to the example 1 or 2, priority is represented by a display layer, and

display is performed on the touch panel portion such that the guiding image is displayed as a front layer, the image of the face is displayed as a back layer, and the image of the face is displayed as a background image seen from gaps of the guiding image.

### Example 5

In the face authentication apparatus according to the example 1 or 2, priority is represented by the degree of recognition, and

another image that makes it possible to determine at least the outline and position of the image of the face is displayed instead of the face of the image.

### Example 6

In the face authentication apparatus according to any one of the examples 1 to 5, the touch panel portion permits a pre-input operation for commanding execution of processing based on the displayed guiding image before the face authentication succeeds.

### Example 7

The face authentication apparatus according to the example 6 starts execution of processing after the face authentication succeeds, in the case where a start operation for commanding that execution of processing be started has been performed in the pre-input operation.

### Example 8

The face authentication apparatus according to any one of the examples 1 to 7 further includes a first detector that detects that a user is approaching in a sleep mode in which power supply to the touch panel portion and the face authenticating unit is shut off, and

a second detector that detects that the user is facing the touch panel portion.

When the first detector detects that the user is approaching, power supply is started to the touch panel portion and the face authenticating unit, and

when the second detector detects that the user is facing the touch panel portion, execution of face authentication to be performed by the face authenticating unit is started.

### Example 9

An image processing apparatus provided with the face authentication apparatus according to any one of the examples 1 to 8.

### Example 10

An image processing apparatus includes the face authentication apparatus according to any one of the examples 1 to 8,

a power supply controller that selectively supplies or shuts off power to devices necessary for execution of image processing in accordance with an input operation performed in a sleep mode, and

a prohibition unit that prohibits the power supply controller from supplying power to a device while the face authentication apparatus is performing face authentication.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an operator determining unit that determines an operator of the image processing apparatus;
a receiving unit that receives, before the operator is determined by the operator determining unit, an operation that causes the image processing apparatus to perform image processing; and
a display that displays, after the receiving unit has received the operation, an image used to cause the operator determining unit to determine the operator.

2. An image display apparatus comprising:
an operator determining unit that determines an operator of the image display apparatus;
a receiving unit that receives an operation that causes the image display apparatus to perform image processing;
a display that displays an image used to cause the operator determining unit to determine the operator; and
a permitting unit that permits, before the operator determining unit determines the operator, the display to display the image used to cause the operator determining unit to determine the operator, in a case where the receiving unit has received the operation.

3. An image processing apparatus comprising:
an operator determining unit that determines an operator of the image processing apparatus;
a receiving unit that receives an operation that causes the image processing apparatus to perform image processing;
a display that displays an image used to cause the operator determining unit to determine the operator; and
a permitting unit that permits, before the operator determining unit determines the operator, the display to display the image used to cause the operator determining unit to determine the operator, in a case where the receiving unit has received the operation.
